(19) United States
(12) Patent Application Publication
(10) Pub. No.: US 2020/0405015 A1
(43) Pub. Date: Dec. 31, 2020

(54) Watch Strap Assembly, Watch Strap and Wearable Apparatus

(71) Applicant: GUANGDONG OPPO MOBILE TELECOMMUNICATIONS CORP., LTD., Dongguan (CN)

(72) Inventor: Kwang Beng Tan, Dongguan (CN)

(21) Appl. No.: 16/886,246

(22) Filed: May 28, 2020

(30) Foreign Application Priority Data
Jun. 25, 2019 (CN) 201920971782.1

(51) Int. Cl. A44C 5/00; A44C 5/18

(52) U.S. Cl. CPC A44C 5/0007; A44C 5/18; A44C 5/0053

(57) ABSTRACT

A watch strap assembly may include a first watch strap and a second watch strap. The first watch strap may include a first strap body and a confining strap. The confining strap may be integrally formed with the first strap body. The confining strap may be located between two opposite ends in a length direction of the first strap body. A channel is defined between the confining strap and the first strap body. The second watch strap may include a second strap body. An end of the second strap body may be capable of passing through the channel and being secured to the first strap body.

### CROSS-REFERENCE TO RELATED APPLICATION(S)

The present application claims the benefits of and priority to Chinese Patent Application No. 201920971782.1, filed on Jun. 25, 2019, the entire contents of which are hereby incorporated by reference in their entireties.

### TECHNICAL FIELD

The present disclosure relates to wearable apparatus technique, and in particular to a watch strap assembly, a watch strap and a wearable apparatus.

### BACKGROUND

In related technologies, the watch strap of a wearable apparatus such as a smart watch and a smart bracelet could be adjusted in length. For example, the length of the watch strap could be adjusted through the use of a pin buckle and a fixing orifice to allow a user to wear the wearable apparatus on a joint of the user (such as a wrist of the user) in a preferred fashion. However, the watch strap whose length is adjustable is relatively expensive to manufacture, and the wearable apparatus suffers a risk of not being worn firmly after a user wears it.

### SUMMARY

A watch strap assembly in accordance with an embodiment in the present disclosure may include a first watch strap and a second watch strap. The first watch strap may include a first strap body and a confining strap. The confining strap may be integrally formed with the first strap body. The confining strap may be located between two opposite ends of the first strap body. A channel may be defined between the confining strap and the first strap body. The second watch strap may include a second strap body. An end of the second strap body may be capable of passing through the channel and being secured to the first strap body.

A watch strap for a wristwatch in accordance with an embodiment in the present disclosure may include a first strap body and a second strap body. The first strap body may have a first end and a second end along a length direction. The first strap may include a bridge located between the first end and the second end and a first fastener located between the first end and the bridge. The second strap body may be configured to extend through a space under the bridge. The second strap body may include a second fastener. The second fastener may be configured to cooperate with the first fastener when the second strap body extends through the space under the bridge.

A wearable apparatus in accordance with an embodiment in the present disclosure may include a dial, a first strap and a second strap. The dial may have a first side and a second side. The first strap may include an elongated first strap body connectable to the first side of the dial, and a flexible confining strap arranged on and be in contact with the first strap body. The second strap may include an elongated second strap body connectable to the second side of the dial. There may be a space generated between the flexible confining strap and the first strap body when the second strap engages with the first strap, such that the second strap may extend through the space.

### BRIEF DESCRIPTION OF DRAWINGS

In order to illustrate the technical solutions in the embodiments of the present disclosure or the prior art more clearly, the drawings required in the description of the embodiments or the prior art will be briefly introduced below. Obviously, the drawings in the following description are merely some embodiments of the present disclosure. For those of ordinary skill in the art, other drawings could be obtained based on these drawings without any more creative work.

FIG. 1 is a top view of a wearable apparatus before being worn according to an embodiment of the present disclosure.

FIG. 2 is a schematic structural diagram of a dial in FIG. 1.

FIG. 3 is a schematic structural diagram of a first watch strap in FIG. 1 according to an embodiment of the present disclosure.

FIG. 4 is a side view of the first watch strap in FIG. 3;

FIG. 5 is a schematic structural diagram of a second watch strap in FIG. 1 according to an embodiment of the present disclosure;

FIG. 6 is a side view of the second watch strap in FIG. 5;

FIG. 7 is a schematic cross-sectional view taken along the section line VII-VII at A in FIG. 1 according to an embodiment of the present disclosure.

FIG. 8 is a schematic structural diagram of the first strap body defining a hole in the wearable apparatus of FIG. 7.

FIG. 9 is a schematic cross-sectional view taken along the section line VII-VII at A in FIG. 1 according to an embodiment of the present disclosure.

FIG. 10 is a schematic structural diagram of a wearable apparatus after a middle segment in FIG. 9 is stretched.

FIG. 11 is an enlarged schematic view at A in FIG. 1 according to an embodiment of the present disclosure.

### DETAILED DESCRIPTION

In order to facilitate understanding of the present disclosure, the present disclosure will be detailed more thoroughly with reference to corresponding drawings. The drawings show the preferred embodiments of the present disclosure. However, the present disclosure could be embodied in various forms and is not limited to the embodiments described herein. Rather, these embodiments are presented to provide a thorough and comprehensive understanding of the present disclosure.

According to a first aspect of the present disclosure, a watch strap assembly is provided. The watch strap assembly could include a first watch strap and a second watch strap. The first watch strap could include a first strap body and a confining strap. The confining strap could be integrally formed with the first strap body. The confining strap could be located between two opposite ends of the first strap body, and the confining strap could be capable of defining a channel with the first strap body between the confining strap and the first strap body. The second watch strap could include a second strap body, an end of the second strap body could be capable of passing through the channel and being secured to the first strap body.

In some embodiments, the confining strap may be located between two opposite ends in a length direction of the first strap body and the confining strap may extend across two opposite ends in a width direction of the first strap body. The confining strap may include a top edge portion, the top edge portion could include a first segment, a middle segment and a second segment connected in sequence along a width direction of the first watch strap. The first segment and the second segment could be both connected to the first strap body. The middle segment is capable of attaching the first strap body, and when the second strap body passes through the middle segment, the middle segment could be upheld and separate from the first strap body and could define the channel.

In some embodiments, the confining strap could include a top edge portion and side edge portions connected to two ends of the top edge portion. The top edge portion could be opposite to and spaced from the first strap body in a thickness direction of the first strap body. The side edge portions could be connected between the top edge portion and the first strap body. The top edge portion, the side edge portions and the first strap body could define the channel.

In some embodiments, the first strap body could define a hole communicating with the channel.

In some embodiments, when the second strap body passes through the channel, the second strap body could abut against an inner wall of the confining strap and uphold the confining strap, the confining strap could accumulate elastic force. When the second strap body exits from the channel, the confining strap could collapse under the effect of the elastic force.

In some embodiments, a first groove and a second groove spaced apart from each other could be defined on the first strap body along the width direction of the first strap body. The first groove could be closed in the circumferential direction, the second groove could be closed in the circumferential direction. A portion between the first groove and the second groove could form the confining strap. The confining strap could be capable of being upheld to define the channel. A port of the channel could be an opening of the first groove and the other port of the channel could be an opening of the second groove.

In some embodiments, the material of the first strap body could include at least one of silica gel, plastic, rubber, leather, and fiber. The material of the second strap body could include at least one of silica gel, plastic, rubber, leather, and fiber.

In some embodiments, an end of the second strap body could be capable of passing through the channel and being secured to the first strap body by magnetic attraction.

In some embodiments, the first strap body could define a catch groove, the second strap body could be provided with a buckle. An end of the second strap body could be capable of passing through the channel from a side of the confining strap away from the catch groove, thus the buckle could be engaged in the catch groove. Or the first strap body could be provided with a buckle, the second strap body could define a catch groove, an end of the second strap body could be capable of passing through the channel from a side of the confining strap away from the buckle, thus the buckle could be engaged in the catch groove.

In some embodiments, the amount of the catch groove could be more than one, a plurality of the catch grooves could be defined at intervals along a length direction of the first watch strap; or a plurality of the catch grooves could be defined at intervals along a length direction of the second watch strap.

In some embodiments, the first watch strap could include a first mounting portion at one end of the first strap body, the catch groove or the buckle could be located between the first mounting portion and the confining strap. The second watch strap could include a second mounting portion at one end of the second strap body, the buckle or the catch groove could be located at the other end of the second strap body.

According to a second aspect of the present disclosure, a wearable apparatus could be provided. The wearable apparatus could include a dial and the above-mentioned watch strap assembly. The dial could include a first side wall and a second side wall arranged opposite to each other. The first watch strap could include a first mounting portion at one end of the first strap body, the second watch strap could include a second mounting portion at one end of the second strap body. The first mounting portion could connect with the first side wall, the second mounting portion could connect with the second side wall.

In some embodiments, one end of the second strap body away from the second mounting portion could be capable of passing through the channel from one side of the confining strap away from the mounting portion and defining a receiving space. When the channel is defined by the confining strap, the confining strap could protrude from one side of the first strap body facing away from the receiving space.

According to a third aspect of the present disclosure, a watch strap could be provided. The watch strap could include a first strap body and a confining strap. The confining strap could be integrally formed with the first strap body. The confining strap could be located between two opposite ends of the first strap body, and the confining strap could be capable of defining a channel with the first strap body between the confining strap and the first strap body. The channel extends along the length direction of the watch strap.

In some embodiments, the confining strap could include a top edge portion. The top edge portion could include a first segment, a middle segment and a second segment connected in sequence along a width direction of the first watch strap. The first segment and the second segment could be both connected to the first strap body. The middle segment could be capable of attaching the first strap body, and the middle segment could be capable of being upheld and separate from the first strap body and defining the channel.

In some embodiments, the confining strap could include a top edge portion and side edge portions connected to two ends of the top edge portion. The top edge portion could be opposite to and spaced from the first strap body in a thickness direction of the first strap body. The side edge portions could be connected between the top edge portion and the first strap body. The top edge portion, the side edge portions and the first strap body could define the channel.

In some embodiments, the first strap body could define a hole communicating with the channel.

In some embodiments, a first groove and a second groove spaced apart from each other could be defined on the first strap body along the width direction of the first strap body. The first groove could be closed in the circumferential direction, the second groove could be closed in the circumferential direction. A portion between the first groove and the second groove could form the confining strap. The confining strap could be capable of being upheld to define the channel. A port of the channel could be an opening of the first groove and the other port of the channel could be an opening of the second groove.

In some embodiments, the material of the first strap body could include at least one of silica gel, plastic, rubber, leather, and fiber.

In some embodiments, the watch strap could include a first mounting portion at one end of the first band body. A buckle could be provided on the first strap body between the first mounting portion and the confining strap or a catch groove could be defined on the first strap body between the first mounting portion and the confining strap.

According to another aspect of the present disclosure, a watch strap for a wristwatch is provided. The watch strap for a wristwatch may include a first strap body and a second strap body. The first strap body may have a first end and a second end along a length direction. The first strap may include a bridge located between the first end and the second end and a first fastener located between the first end and the bridge. The second strap body may be configured to extend through a space under the bridge. The second strap body may include a second fastener. The second fastener may be configured to cooperate with the first fastener when the second strap body extends through the space under the bridge.

In some embodiments, the space may be defined between the bridge and the first strap body under the bridge.

In some embodiments, a hole may be defined in the first strap body under the bridge and communicated with the space.

In some embodiments, one of the first and second fasteners may include a plurality of apertures, the other one of the first and second fasteners may include a buckle. When the second strap body extends through the space under the bridge, the buckle may be engaged in one of the apertures.

In some embodiments, an extending direction of the first strap body may be substantially perpendicular to an extending direction of the bridge.

In some embodiments, the bridge and the first strap may be made of a single piece.

According to another aspect of the present disclosure, a wearable apparatus is provided. The wearable apparatus may include a dial, a first strap and a second strap. The dial may have a first side and a second side. The first strap may include an elongated first strap body connectable to the first side of the dial, and a flexible confining strap arranged on and be in contact with the first strap body. The second strap may include an elongated second strap body connectable to the second side of the dial. There may be a space generated between the flexible confining strap and the first strap body when the second strap engages with the first strap, such that the second strap may extend through the space.

In some embodiments, a plurality of apertures may be defined in the first strap body and located between the dial and the flexible confining strap.

In some embodiments, the second strap body may include a buckle configured to be engaged in the apertures after the second strap extends through the space.

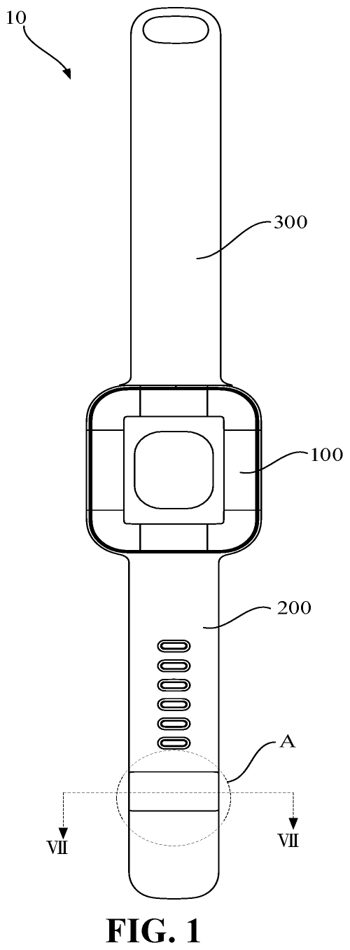

With reference to FIG. 1, in some embodiments, a wristwatch (including a smart watch and a mechanical watch) is taken as an example to illustrate a wearable apparatus 10. The wearable apparatus 10 may include a dial 100 with a first watch strap 200 and a second watch strap 300. The first watch strap 200 may connect with a side of the dial 100, and the second watch strap 300 may connect with an opposite side of the dial 100. The first watch strap 200 and the second watch strap 300 may cooperate with each other to enable a user's wearing operation on the wearable apparatus 10 like a wristwatch. It should be appreciated that, in other embodiments, the wearable apparatus 10 may also be a smart bracelet or a smart armlet, which is not limited herein.

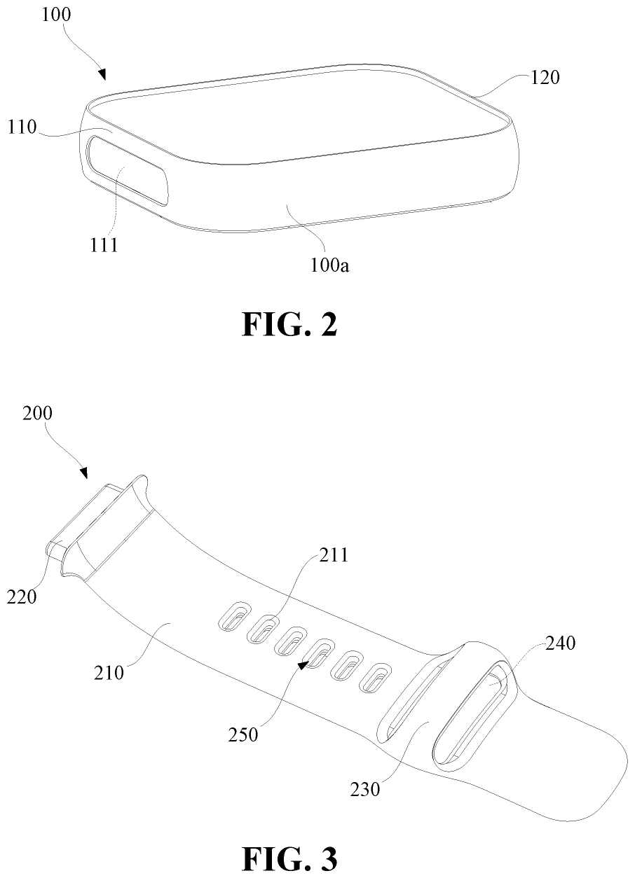

As shown in FIG. 2, the dial 100 may include a first side wall 110 and a second side wall 120 arranged opposite to each other. In some embodiments, the first side wall 110 may define a first mounting groove 111 and the second side wall 120 may define a second mounting groove. It should be noted that, the first side wall 110 and the second side wall 120 could be regarded as a part of the side peripheral face 100a of the dial 100. In other words, the dial 100 could define the first mounting groove 111 and the second mounting groove on its side peripheral face 100a.

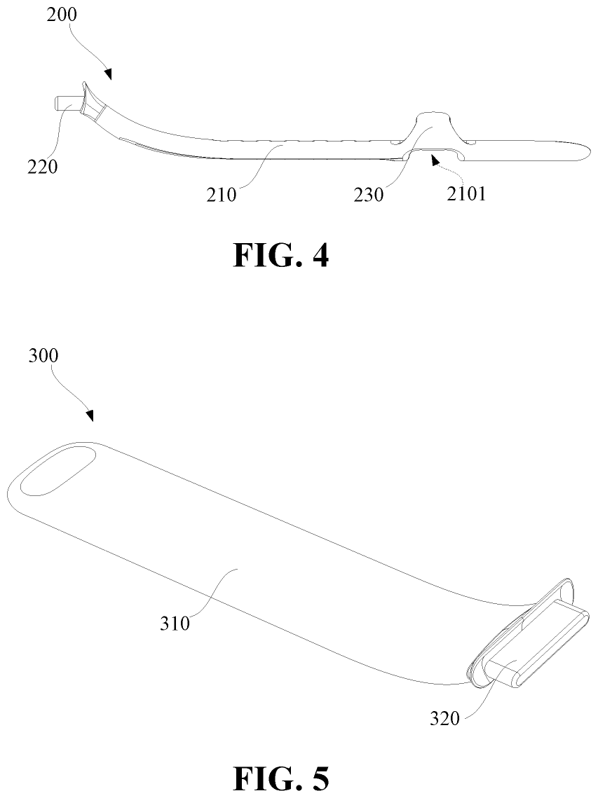

The first watch strap 200 may be connected to the first side wall 110 of the dial 100. In some embodiments, referring to FIGS. 3 and 4, the first watch strap 200 may include a first strap body 210 and a first mounting portion 220 connected to one end of the first strap body 210. The first mounting portion 220 could be inserted in the first mounting groove 111, so as to realize a detachable connection between the first watch strap 200 and the dial 100. For example, the first mounting portion 220 may be inserted in the first mounting groove 111 and then could be locked in the mounting groove 111 through a fastener such as a spring bar. It should be appreciated that, in other embodiments, the first mounting portion 220 could be omitted. In these cases, the first strap body 210 could be connected to the first side wall 110 of the dial 100. For example, the first strap body 210 could be bonded to the first side wall 110 of the dial 100 by adhesion.

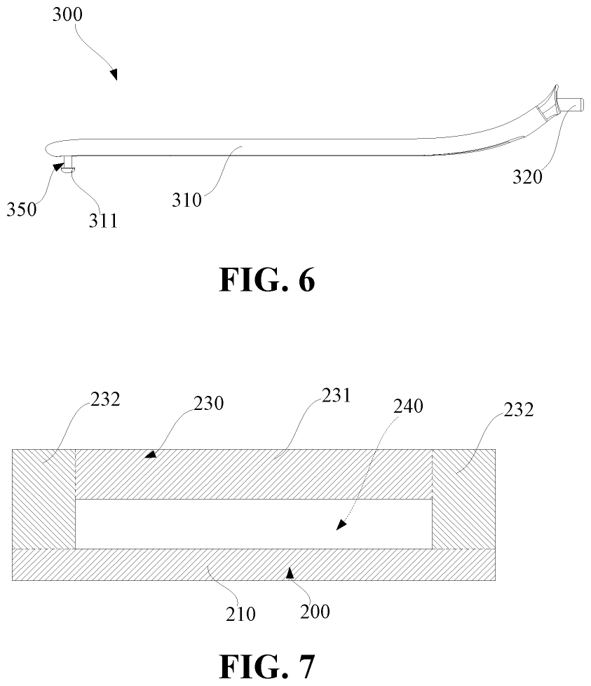

The second watch strap 300 may be connected to the second side wall 120 of the dial 100. In some embodiments, referring to FIGS. 5 and 6, the second watch strap 300 may include a second strap body 310 and a second mounting portion 320 connected to one end of the second strap body 310. The second mounting portion 320 could be inserted in the second mounting groove, so as to realize a detachable connection between the second watch strap 300 and the dial 100. For example, the second mounting portion 320 may be inserted in the second mounting groove and then could be locked in the mounting groove through a fastener such as a spring bar. It should be appreciated that, in other embodiments, the second mounting portion 320 could be omitted. In these cases, the second strap body 310 could be connected to the second side wall 120 of the dial 100. For example, the second strap body 310 may be bonded to the second side wall 120 of the dial 100 by adhesion.

Both the first watch strap 200 and the second watch strap 300 could be bent and deformed under external force. For example, the first watch strap 200 and the second watch strap 300 may both be flexible straps. In these cases, the materials of the first strap body 210 and the second strap body 310 may both be flexible materials. The flexible material may include, but be not limited to, at least one of silica gel, plastic, rubber, leather and fiber. The first watch strap 200 and the second watch strap 300 could be buckled with each other after being bent and deformed to form a ring-shaped receiving space, thus the wearable apparatus 10 could be worn to a joint such as a wrist of a human body.

In some embodiments, as shown in FIG. 3 and FIG. 4, the first watch strap 200 may include a confining strap 230 which may be called a bridge 230. The confining strap 230 is located between two opposite ends in a length direction of the first strap body 210. The confining strap 230 and the first strap body 210 may be integrally formed. For example, the confining strap 230 and the first strap body 210 could be integrally made by injection molding. A channel 240 could be defined between the confining strap 230 and the first strap body 210. In some embodiments, the channel 240 may extend along the length direction of the first watch strap 200. When the channel 240 is defined by the confining strap 230, the confining strap 230 may protrude from a side of the first strap body 210 facing away from the receiving space.

An end of the second strap body 310 away from the second mounting portion 320 could pass through the channel 240 from a side of the confining strap 230 away from the first mounting portion 220 and be fixed to the first strap body 210. In some embodiments, the first strap body 210 could define a catch groove or aperture 250, which is located between the first mounting portion 220 and the confining strap 230. That is, the catch groove 250 could be located in an extending direction of the channel 240. As shown in FIGS. 5 and 6, a buckle 350 may be provided on an end of the second strap body 310 away from the second mounting portion 320, and the end of the second strap body 310 provided with the buckle 350 could pass through the channel 240 from a side of the confining strap 230 away from the catch groove 250, so that the buckle 350 is engaged in the catch groove 250, thus the first watch strap 200 and the second watch strap 300 could be fastened to each other.

It should be appreciated that, in other embodiments, the buckle 350 could be provided on the first strap body 210 between the first mounting portion 220 and the confining strap 230, and the second strap body 310 could define a catch groove or aperture on an end away from the second mounting portion 320. It should be noted that, the amount of the above-mentioned catch grooves 250 may be more than one. For example, when multiple catch grooves 250 are defined in the first strap body 210, the multiple catch grooves 250 could be arranged at intervals along the length direction of the first watch strap 200. In these cases, the user could adjust the length of the second strap body 310 passing through the channel 240 according to the size of his/her wrist, so that the buckle 350 is engaged in the most suitable catch groove 250 to ensure that the user feels comfort after wearing the apparatus 10. Of course, in other embodiments, the multiple catch grooves 250 may also be defined in the second strap body 310.

In other embodiments, in addition to the buckle-connection between the buckle 350 and the catch groove 250, after an end of the second strap body 310 passes through the channel 240, the second strap body 310 may also be fixed to the first strap body 210 through magnetic attraction. For example, a first magnetic element may be embedded in the first strap body 210, and a second magnetic element may be embedded in the second strap body 310. The first magnetic element could be an electromagnet or a permanent magnet. The second magnetic element could be an electromagnet or a permanent magnet. The magnetic directions of the first magnetic element and the second magnetic element are opposite to each other. The second strap body 310 could be fixed to the first strap body 210 by magnetic attraction between the second magnetic element and the first magnetic element. In some embodiments, the first magnetic elements may be arranged at intervals along the length direction of the first watch strap 200. It should be noted that, one of the first magnetic element and the second magnetic element could be replaced by a metal piece.

In the above-mentioned wearable apparatus 10, an end of the second strap body 310 could pass through the channel 240 from the side of the confining strap 230 away from the catch groove 250, so that the buckle 350 is engaged in a catch groove 250 to realize the fixing connection between the first watch strap 200 and the second watch strap 300, thus the wearable apparatus 10 could be worn on a joint such as a wrist of the user. The confining strap 230 could force the portion of the second strap body 310 without the buckle 350 to attach the first strap body 210, to prevent the separation between part of the second strap body 310 and the first strap body 210. On the one hand, since the confining strap 230 is integrally formed with the first strap body 210, the processing of the first watch strap 200 could be facilitated, and the fabrication cost could be reduced. On the other hand, since the confining strap 230 could always be held at a fixed position on the first strap body 210 and could not slide with respect to the first strap body 210, the degree of attachment between the second strap body 310 and the first strap body 210 after the second strap body 310 passes through the channel 240 is increased, thus the user's experience is enhanced.

The confining strap 230 and the first strap body 210 could define the channel 240 in various ways.

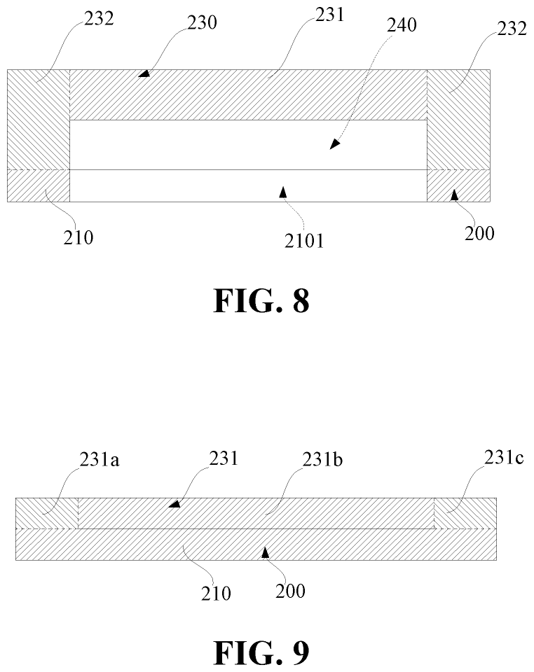

In some embodiments, as shown in FIG. 7, the confining strap 230 may include a top edge portion 231 and side edge portions 232 connected to two opposite sides of the top edge portion 231. The top edge portion 231 is opposite to and spaced from the first strap body 210 in a thickness direction of the first strap body 210. The side edge portions 232 may be connected between the top edge portion 231 and the first strap body 210. The top edge portion 231, the side edge portions 232, and the first strap body 210 may collectively define the above-mentioned channel 240. In some embodiments, as shown in FIG. 8, the first strap body 210 may define a hole 2101 communicating with the channel 240. In this way, when the buckle 350 is detached from the catch groove 250 (for example, when the buckle 350 is not engaged firmly with the catch groove 250 and the buckle 350 is detached from the catch groove 250, or after the user wears the wearable apparatus 10 on a joint such as a wrist, the user's strenuous exercise may cause the buckle 350 to detach from the catch groove 250), the second strap body 310 would not be easily out from the confining strap 230 and separate from the first strap body 210. In other words, the wearable apparatus 10 would not be easily detached from the joint such as the wrist. This is because, during the process the second strap body 310 exiting from the confining strap 230, the second strap body 310 will press the buckle 350 to be engaged in the hole 2101 under the resistance of the top edge portion 231. Therefore, the hole 2101 could prevent the second strap body 310 with the buckle 350 from continuing to exit. On the other hand, the hole 2101 could also reduce material expense of the first watch strap 200 and decrease the manufacturing cost.

In some embodiments, when the second strap body 310 passes through the channel 240, the second strap body 310 could abut against the inner wall of the confining strap 230 and the confining strap 230 could be stretched. In other words, the cross-sectional area of the channel 240 defined by the confining strap 230 may be less than the cross-sectional area of the second strap body 310. In these cases, the confining strap 230 could accumulate elastic force. The confining strap 230 could wrap the second strap body 310 in the channel 240 with the elastic force. FIGS. 3 and 4 depict schematic structural diagrams of the first watch strap 200, wherein, the confining strap 230 of the first watch strap 200 is in a state when the confining strap 230 is being stretched after the second strap body 310 passes through the channel 240. After the second strap body 310 exits from the channel 240, as shown in FIG. 8, the confining strap 230 could collapse under the effect of the elastic force. It should be appreciated that, in other embodiments, the channel 240 defined between the confining strap 230 and the first strap body 210 could accommodate the second strap body 310. That is, the cross-sectional area of the channel 240 defined between the confining strap 230 and the first strap body 210 is larger than the cross-sectional area of the second strap body 310. When the first watch strap 200 and the second watch strap 300 mate with each other, the confining strap 230 does not need to be elastically deformed.

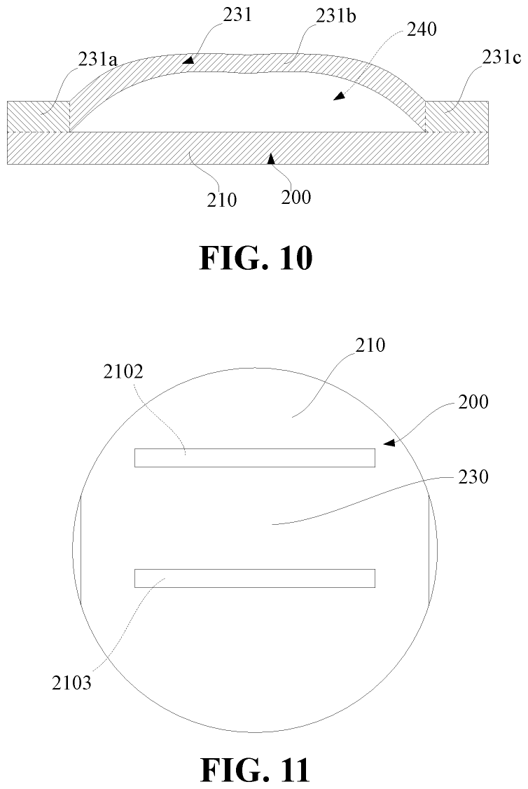

In some embodiments, the side edge portions 232 of the confining strap 230 may be omitted. In these cases, the confining strap 230 may include a top edge portion 231. As shown in FIG. 9, the top edge portion 231 could include a first segment 231a, a middle segment 231b and a second segment 231c connected in sequence along the width extension direction of the first watch strap 200. The first segment 231a and the second segment 231c may both be connected to the first strap body 210. It may also be appreciated that, the first segment 231a and the second segment 231c may both be extensions from the first strap body 210. The middle segment 231b could attach the first strap body 210. As shown in FIG. 10, the middle segment 231b could be upheld to be spaced apart from the first strap body 210 so as to define the above-mentioned channel 240. For example, after the second strap body 310 passes through the channel 240, the second strap body 310 could uphold the middle segment 231b. When the middle segment 231b is upheld, the middle segment 231b could accumulate elastic force. When the middle segment 231b releases the elastic force, the middle segment 231b could attach the first strap body 210 once again.

In some embodiments, as shown in FIG. 11, the first groove 2102 and the second groove 2103 spaced apart from each other are defined on the first strap body 210. The first groove 2102 and the second groove 2103 may both be along the width direction of the first strap body 210. The first groove 2102 may be closed in the circumferential direction. The second groove 2103 may be closed in the circumferential direction. A portion between the first groove 2102 and the second groove 2103 may form the confining strap 230. The confining strap 230 could be upheld to define a channel 240. One port of the channel 240 may be an opening of the first groove 2102 and the other port of the channel 240 may be an opening of the second groove 2103. When the confining strap 230 is upheld, the confining strap 230 could accumulate the elastic force. When the confining strap 230 releases the elastic force, the confining strap 230 could collapse. An outer face of the collapsed confining strap 230 may be flush with an outer face of the first strap body 210. In some embodiments, the first groove 2102 and the second groove 2103 may also be scribed lines. In these cases, when the confining strap 230 is in a state of not being upheld, that is, the first watch strap 200 does not mate with the second watch strap 300, sides of the confining strap 230 adjacent to the first groove 2102 and the second groove 2103 could be in contact with the first strap body 210, and the outer face of the confining strap 230 could be flush with the outer face of the first strap body 210.

Another aspect of the present disclosure provides a watch strap. The watch strap may include a first strap body 210 and a confining strap 230. The confining strap 230 could be integrally formed with the first strap body 210. The confining strap 230 could be located between two opposite ends in a length direction of the first strap body 210, and a channel 240 could be defined between the confining strap 230 and the first strap body 210. The channel 240 extends along the length direction of the watch strap. It should be noted that, the strap of the embodiments of the present disclosure could be produced separately and applied to the wearable apparatus 10, and the structural characteristics of the strap could be exactly the same as those of the first watch strap 200 in the embodiments of the present disclosure, and are thus not detailed hereafter.

The technical features of the embodiments described above could be arbitrarily combined. For the sake of brevity, all the possible combinations of the technical features are not enumerated and described. However, as long as there is no contradiction in the combination of these technical features, it should be considered within the scope described in this specification.

The above-mentioned embodiments only express several implementations of the present disclosure, whose descriptions are specific and detailed, but could be construed as a limitation on the patent scope of the present disclosure. It should be noted that, for those of ordinary skill in the art, several modifications and improvements could be made without departing from the concept of the present disclosure, which all belong to the protection scope of the present disclosure. Therefore, the protection scope of this disclosure shall be subject to the appended claims.

What is claimed is:

1. A watch strap assembly, comprising:
a first watch strap, comprising a first strap body and a confining strap, the confining strap is integrally formed with the first strap body, the confining strap is located between two opposite ends of the first strap body, and a channel is defined between the confining strap and the first strap body; and
a second watch strap, comprising a second strap body, an end of the second strap body is capable of passing through the channel and being secured to the first strap body.

2. The watch strap assembly according to claim 1, wherein the confining strap is located between two opposite ends in a length direction of the first strap body and the confining strap extends across two opposite ends in a width direction of the first strap body; and the confining strap comprises a top edge portion, the top edge portion comprises a first segment, a middle segment and a second segment connected in sequence along a width direction of the first watch strap, the first segment and the second segment are both connected to the first strap body, the middle segment is capable of attaching the first strap body, and when the second strap body passes through the middle segment, the middle segment is upheld and separated from the first strap body and defines the channel.

3. The watch strap assembly according to claim 1, wherein the confining strap comprises a top edge portion and side edge portions connected to two ends of the top edge portion, the top edge portion is opposite to and spaced from the first strap body in a thickness direction of the first strap body, the side edge portions are connected between the top edge portion and the first strap body, the top edge portion, the side edge portions and the first strap body define the channel.

4. The watch strap assembly according to claim 3, wherein the first strap body defines a hole communicating with the channel.

5. The watch strap assembly according to claim 3, wherein when the second strap body passes through the channel, the second strap body abuts against an inner wall of the confining strap and upholds the confining strap, the confining strap accumulates elastic force; and when the second strap body exits from the channel, the confining strap collapses under the effect of the elastic force.

6. The watch strap assembly according to claim 1, wherein a first groove and a second groove spaced apart from each other are defined on the first strap body, the first groove and the second groove are both along a width direction of the first strap body, the first groove is closed in the circumferential direction, the second groove is closed in the circumferential direction, a portion between the first groove and the second groove forms the confining strap; and the confining strap is capable of being upheld to define the channel, a port of the channel is an opening of the first groove and the other port of the channel is an opening of the second groove.

7. The watch strap assembly according to claim 1, wherein the material of the first strap body comprises at least one of silica gel, plastic, rubber, leather, or fiber; and the material of the second strap body comprises at least one of silica gel, plastic, rubber, leather, or fiber.

8. The watch strap assembly according to claim 1, wherein an end of the second strap body is capable of passing through the channel and being secured to the first strap body by magnetic attraction.

9. The watch strap assembly according to claim 1, wherein the first strap body defines a catch groove, the second strap body is provided with a buckle, an end of the second strap body is capable of passing through the channel from a side of the confining strap away from the catch groove, thus the buckle is engaged in the catch groove; or the first strap body is provided with a buckle, the second strap body defines a catch groove, an end of the second strap body is capable of passing through the channel from a side of the confining strap away from the buckle, thus the buckle is engaged in the catch groove.

10. The watch strap assembly according to claim 9, wherein the amount of the catch grooves is more than one, a plurality of the catch grooves are defined at intervals along a length direction of the first watch strap; or a plurality of the catch grooves are defined at intervals along a length direction of the second watch strap.

11. The watch strap assembly according to claim 9, wherein the first watch strap comprises a first mounting portion at one end of the first strap body, the catch groove or the buckle is located between the first mounting portion and the confining strap; and the second watch strap comprises a second mounting portion at one end of the second strap body, the buckle or the catch groove is located at the other end of the second strap body.

12. A watch strap for a wristwatch, comprising:
a first strap body having a first end and a second end along a length direction, the first strap comprising a bridge located between the first end and the second end and a first fastener located between the first end and the bridge; and
a second strap body configured to extend through a space under the bridge, the second strap body comprises a second fastener, wherein the second fastener is configured to cooperate with the first fastener when the second strap body extends through the space under the bridge.

13. The watch strap according to claim 12, wherein the space is defined between the bridge and the first strap body under the bridge.

14. The watch strap according to claim 13, wherein a hole is defined in the first strap body under the bridge and communicated with the space.

15. The watch strap according to claim 13, wherein one of the first and second fasteners comprises a plurality of apertures, the other one of the first and second fasteners comprise a buckle, when the second strap body extends through the space under the bridge, the buckle is engaged in one of the apertures.

16. The watch strap according to claim 12, wherein an extending direction of the first strap body is substantially perpendicular to an extending direction of the bridge.

17. The watch strap according to claim 12, wherein the bridge and the first strap are made of a single piece.

18. A wearable apparatus, comprising:
a dial having a first side and a second side;
a first strap comprising:
an elongated first strap body connectable to the first side of the dial; and
a flexible confining strap arranged on and be in contact with the first strap body; and
a second strap comprising:
an elongated second strap body connectable to the second side of the dial,
wherein there is a space generated between the flexible confining strap and the first strap body when the second strap engages with the first strap, such that the second strap extends through the space.

19. The wearable apparatus according to claim 18, wherein a plurality of apertures are defined in the first strap body and located between the dial and the flexible confining strap.

20. The wearable apparatus according to claim 19, wherein the second strap body comprises a buckle configured to be engaged in the apertures after the second strap extends through the space.
